(19) United States
(12) Patent Application Publication
(10) Pub. No.: US 2025/0268283 A1
(43) Pub. Date: Aug. 28, 2025

(54) CANNABINOID-INFUSED FOOD ARTICLES WITH TAILORED PSYCHOACTIVE PROPERTIES

(71) Applicant: Winston Allen Porter, Brookhaven, GA (US)

(72) Inventor: Winston Allen Porter, Brookhaven, GA (US)

(21) Appl. No.: 19/061,115

(22) Filed: Feb. 24, 2025

Related U.S. Application Data
(60) Provisional application No. 63/563,094, filed on Mar. 8, 2024.
(60) Provisional application No. 63/556,594, filed on Feb. 22, 2024.

(51) Int. Cl. A23L 2/38; A23L 2/54; A23L 2/56; A23L 2/60

(52) U.S. Cl. CPC A23L 2/38; A23L 2/54; A23L 2/56; A23L 2/60

(57) ABSTRACT

Described herein are consumable food articles that are infused with a plurality of cannabinoids. The food articles described herein harness a synergistic blend of multiple cannabinoids. The food articles provide a customizable and dynamic consumer experience, with enhanced control over the psychoactive and therapeutic effects, consistent dosing, and improved onset times. The food articles will cater to a more diverse consumer base, seeking both nuanced recreational experiences and specific health benefits, thereby expanding the current scope of the cannabis consumable product market.

### CROSS-REFERENCE TO RELATED APPLICATIONS

This application claims the benefit of and priority to co-pending U.S. Provisional Patent Application Nos. 63/556,594, filed on Feb. 22, 2024, and 63/563,094, filed on Mar. 8, 2024. The contents of each application are incorporated by reference herein in their entireties.

### BACKGROUND

The manufacture and sale of consumable food products infused with cannabinoids are on the rise. For example, the cannabis beverage industry represents a dynamic and rapidly growing segment of the broader cannabis market. This field encompasses the production, distribution, and marketing of beverages infused with cannabinoids, the active compounds found in the cannabis plant. The industry intersects with both the burgeoning legal cannabis sector and the established beverage industry, blending expertise from both worlds to create a new category of consumable products.

A significant portion of the current market is focused on CBD-only products, catering to consumers seeking non-psychoactive health benefits. Psychoactive beverages predominantly feature THC, with limited exploration of other psychoactive cannabinoids. Furthermore, existing products often have limitations in terms of onset time, duration of effects, and consistency in dosing. The psychoactive experience is generally limited to the effects of single cannabinoids.

There is a noticeable gap in the market for beverages that utilize a synergistic blend of multiple cannabinoids to create tailored psychoactive and therapeutic experiences. The beverages described herein address this gap.

### SUMMARY

Described herein are consumable food articles that are infused with a plurality of cannabinoids. The food articles described herein harness a synergistic blend of multiple cannabinoids. The food articles provide a customizable and dynamic consumer experience, with enhanced control over the psychoactive and therapeutic effects, consistent dosing, and improved onset times. The food articles will cater to a more diverse consumer base, seeking both nuanced recreational experiences and specific health benefits, thereby expanding the current scope of the cannabis consumable product market.

Other compositions, apparatus, methods, features, and advantages will be or become apparent to one with skill in the art upon examination of the following drawings and detailed description. It is intended that all such additional compositions, apparatus, methods, features and advantages be included within this description, be within the scope of the present disclosure, and be protected by the accompanying claims.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” “having,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a pharmaceutically acceptable carrier” includes, but is not limited to, mixtures or combinations of two or more such carriers, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated +10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to prepare the compositions disclosed herein as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the terms “optional” or “optionally” means that the subsequently described event or circumstance can or cannot occur, and that the description includes instances where said event or circumstance and instances where it does not.

The term “enhanced or “enhancing” as used herein is defined as improving a feature or providing a desired effect when ingesting the food articles described herein when compared to prior ingestion of the food article. In the alternative, the enhancement can reduce an undesirable feature or symptom. For example, a subject undergoing stress can consume a food article described herein and experience reduced stress as well increased relaxation.

Delta-8 THC (Δ8-Tetrahydrocannabinol) possesses psychoactive properties. Delta-8 THC offers a milder high when compared to Delta-9 THC, characterized by relaxation, euphoria, and potential pain relief, with a lower likelihood of anxiety. Not wishing to be bound by theory, Delta-8 provides a smoother psychoactive experience, suitable for consumers seeking relaxation without intense psychoactivity. In one aspect, Delta-8 THC is from 10 mg to 30 mg per serving of food article.

CBG (Cannabigerol) is a non-psychoactive cannabinoid. Not wishing to be bound by theory, CBG possesses potential anti-inflammatory, pain-relieving, and neuroprotective properties. CBG also possesses potential therapeutic benefits and enhances the overall wellness profile of the beverages described herein. In one aspect, CBG is from 10 mg to 30 mg per serving of food article.

THCV (Tetrahydrocannabivarin) is a psychoactive cannabinoid with a unique profile, known for providing energy, suppressing appetite, and potentially aiding in diabetes management. Its effects are typically clear-headed and stimulating. THCV also possesses energizing and focus-enhancing properties, making the beverage suitable for consumers seeking mental clarity and alertness. In one aspect, THCV is from 5 mg to 10 mg per serving of food article.

HHC (Hexahydrocannabinol) is a hydrogenated form of THC with effects similar to traditional THC. HHC produces relaxing and euphoric sensations. HHC offers a different spectrum of effects to enhance the food products overall psychoactive profile. In one aspect, HHC is from 10 mg to 20 mg per serving of food article.

CBD (Cannabidiol) is a non-psychoactive cannabinoid with a wide range of potential health benefits, including anxiety relief, pain reduction, and anti-inflammatory properties. CBD provides balance to the psychoactive effects of other cannabinoids and to contribute to the therapeutic potential of the beverage. In one aspect, CBD is from 15 mg to 30 mg per serving of food article.

Delta-9 THC (Δ9-Tetrahydrocannabinol) is the primary psychoactive component in cannabis, known for producing strong euphoria, relaxation, and sensory alteration. In one aspect, Delta-9 THC is from 5 mg to 10 mg per serving of food article.

Delta-10 THC (Δ10-Tetrahydrocannabinol) is similar to Delta-8 but with a more sativa-like, energizing effect. It provides uplifting and energizing effects, complementing more sedative cannabinoids. In one aspect, Delta-10 THC is from 10 mg to 20 mg per serving of food article.

THC-P (Tetrahydrocannabiphorol) is a newly discovered cannabinoid, significantly more potent than Delta-9 THC, potentially offering profound psychoactive effects. In one aspect, THC-P is from 1 mg to 3 mg per serving of food article.

HHC-P (Hydrogenated THC-P) is a hydrogenated version of THC-P, with assumed similar potency and effects. In one aspect, HHC-P is from 1 mg to 3 mg per serving of food article.

CBN (Cannabinol) possesses sedative properties, often used to promote sleep. In one aspect, CBN is from 5 mg to 10 mg per serving of food article.

CBC (Cannabichromene) can interact with TRPV1 and 5-HT1A serotonin receptors, potentially boosting mood and emotional well-being.

CBDA (Cannabidiolic Acid) and THCA (Tetrahydrocannabinolic Acid) exhibit potent anti-inflammatory properties.

### Food Articles Composed of Blends of Cannabinoids

Described herein are consumable food articles that are infused with a plurality of cannabinoids. The food articles described herein harness a synergistic blend of multiple cannabinoids. The food articles provide a customizable and dynamic consumer experience, with enhanced control over the psychoactive and therapeutic effects, consistent dosing, and improved onset times.

The novel blend of multiple cannabinoids present in the food articles, each chosen for their specific effects and combined in precise ratios, creates a unique, multifaceted experience for the consumer. The combination of these cannabinoids is designed to leverage the entourage effect, where the combined impact of various cannabinoids is greater than the sum of their individual effects.

The food articles described herein offer consumers a tailored experience, meticulously designed through the innovative blending of cannabinoids. This precision blending is based on an advanced understanding of cannabinoid-receptor interactions within the body's endocannabinoid system, primarily involving CB1 and CB2 receptors. Each cannabinoid in the blend is selected for its unique interaction with these receptors. However, cannabinoid science reveals a complex picture: overloading a receptor with a high concentration of a single cannabinoid can lead to receptor saturation or desensitization, potentially diminishing the intended effect over time. To circumvent this, the food articles described herein provide a diversified cannabinoid profile, wherein each cannabinoid is dosed to optimally engage with the receptors without causing overload.

Furthermore, when a second cannabinoid is introduced, it interacts with receptors in a complementary manner, engaging with those that may be less affected by the first cannabinoid. This approach aligns with the principle of the entourage effect, where the therapeutic benefits of cannabis compounds are enhanced when used together, compared to when used in isolation. The methodology of blending different cannabinoids to produce or elicit different consumer responses brings a new level of sophistication and effectiveness to cannabinoid-infused food articles, marking a significant advancement in the industry.

Currently, the market is populated with products featuring basic isomer formulations, often focusing on single cannabinoids like Delta 8 or Delta 9 in isolation. These products typically present these cannabinoids as standalone active ingredients, without exploring the potential for more intricate and synergistic blends.

The food articles described herein go beyond the market norm of single-cannabinoid products by adopting an advanced approach to blending various cannabinoids. It is not merely about including different cannabinoids in a food article; it is about the strategic and scientifically informed combination of these cannabinoids to achieve specific, enhanced effects. The precise ratios used in this blend are key to unlocking synergistic effects that elevate the consumer experience beyond what single-cannabinoid products offer.

The preparation of the of the food articles described herein utilizes a “building block” scaling methodology in cannabinoid dosing. The ‘building block’ approach involves using each cannabinoid as a modular component, with defined serving sizes, to create a customizable and adaptable beverage formulation. This methodology allows for constant adjustment and innovation with respect to producing tailored food articles. By altering the ratios and combinations of these “building blocks,” the food articles described herein can be tailored to produce a wide range of effects as discussed in detail below.

Moreover, each cannabinoid's serving size is carefully determined based on its potency and effects, ensuring a balanced and effective final product. This precision allows for consistent experiences across servings and batches. The ability to modify dosages and combinations provides unparalleled flexibility in responding to consumer preferences, market trends, and regulatory changes.

The preparation of the food articles described herein leverages an in-depth understanding of cannabinoid interactions with CB1 and CB2 receptors. Recognizing that saturating these receptors with a single type of cannabinoid can lead to reduced effectiveness. The methodology described herein strategically combines different cannabinoids. This ensures engagement with a broader range of receptors, providing a more complex and satisfying experience than what is available with existing products.

Finally, the food articles described herein are not confined to a single formulation. They encompass a versatile range of products, each tailored for distinct effects such as relaxation, energy, focus, or wellness. This level of diversity and customizability in product offerings represents a novel approach in the cannabis market, where products typically have more limited and singular effects.

Using the methodology described above, described herein is a series of food articles, each designed to cater to specific consumer preferences and needs. The food articles described embody the versatility and adaptability of the food articles and methodology for producing the same. The food articles described herein offer customization options, allowing consumers to choose a formulation that best aligns with their desired effects, whether it's for recreational enjoyment, specific health benefits, or a combination of both.

In one aspect, the food articles described herein can provide enhanced psychoactive effects or properties. In one aspect, food articles with higher concentrations of Delta-8 THC and HHC can induce a state of mild euphoria and relaxation. In another aspect, food articles with higher levels of THCV and CBG can enhance mental clarity and focus. These cannabinoids work together to provide an energized, yet clear-headed experience. In another aspect, food articles with Delta-9 THC complemented by CBD can temper the intensity of the high and ensure a more manageable and enjoyable experience.

In one aspect, the food articles described herein can provide enhanced therapeutic effects or properties. In one aspect, food articles with CBD can provide anxiolytic and calming properties. It works in synergy with other cannabinoids to provide relief from stress and anxiety, without the intense psychoactive effects of THC. In another aspect, food articles with CBG in combination with CBD can provide pain relief and anti-inflammatory properties. In another aspect, food articles with CBN in combination with other cannabinoids can provide sedative properties and aid in improving sleep quality.

In one aspect, the food article includes a blend of Delta-8 THC, CBG, CBD, THCV, and HHC. In one aspect, in this blend, Delta-8 THC is in an amount of about 12 mg to about 18 mg (preferably 12 mg to about 18 mg, or 15 mg) per serving of food article, CBG is in an amount of about 16 mg to about 24 (preferably 18 mg to about 22 mg, or 20 mg) mg per serving of food article, CBD is in an amount of about 20 mg to about 30 mg (preferably 24 mg to about 26 mg, or 25 mg) per serving of food article, THCV is in an amount of about 5 mg to about 9 mg (preferably 6 mg to about 8 mg, or 7 mg) per serving of food article, and HHC is in an amount of about 8 mg to about 12 mg (preferably 9 mg to about 11 mg, or 10 mg) per serving of food article. This formulation provides a balanced blend, designed to provide a moderate psychoactive experience with wellness benefits.

In one aspect, the food article includes a blend of Della-8 THC, CBG, CBD, THCV, and HHC. In one aspect, in this blend, Delta-8 THC is in an amount of about 16 mg to about 24 mg (preferably 18 mg to about 22 mg, or 20 mg) per serving of food article, CBG is in an amount of about 12 mg to about 18 mg (preferably 14 mg to about 16 mg, or 15 mg) per serving of food article, CBD is in an amount of about 24 mg to about 36 mg (preferably 28 mg to about 32 mg, or 30 mg) per serving of food article, THCV is in an amount of about 4 mg to about 6 mg (preferably 4.5 mg to about 5.5 mg, or 5 mg) per serving of food article, and HHC is in an amount of about 8 mg to about 12 mg (preferably 9 mg to about 11 mg, or 10 mg) per serving of food article. This formulation provides a balanced blend, designed to provide enhanced relaxation, stress relief, or a combination thereof.

In one aspect, the food article includes a blend of Delta-8 THC, CBG, CBD, THCV, and HHC. In one aspect, in this blend, Delta-8 THC is in an amount of about 8 mg to about 12 mg (preferably 9 mg to about 1 mg, or 10 mg) per serving of food article, CBG is in an amount of about 16 mg to about 24 mg (preferably 18 mg to about 22 mg, or 20 mg) per serving of food article, CBD is in an amount of about 12 mg to about 18 mg (preferably 14 mg to about 16 mg, or 15 mg) per serving of food article, THCV is in an amount of about 8 mg to about 12 mg (preferably 9 mg to about 11 mg, or 10 mg) per serving of food article, and HHC is in an amount of about 4 mg to about 6 mg (preferably 4.5 mg to about 5.5 mg, or 5 mg) per serving of food article. This formulation provides a balanced blend, designed to provide enhanced energy, focus, or a combination thereof.

In one aspect, the food article includes a blend of Delta-8 THC, CBG, CBD, and HHC. In one aspect, in this blend, Delta-8 THC is in an amount of about 4 mg to about 6 mg (preferably 4.5 mg to about 5.5 mg, or 5 mg) per serving of food article, CBG is in an amount of about 24 mg to about 36 mg (preferably 28 mg to about 32 mg, or 30 mg) per serving of food article, CBD is in an amount of about 32 mg to about 48 mg (preferably 38 mg to about 42 mg, or 40 mg) per serving of food article, and HHC is in an amount of about 4 mg to about 6 mg (preferably 4.5 mg to about 5.5 mg, or 5 mg) per serving of food article. This formulation provides a balanced blend, designed to provide enhanced sleep.

In one aspect, the food article includes a blend of CBD, Delta-9 THC, Delta-8 THC, and HHC. In one aspect, in this blend, Delta-8 THC is in an amount of about 40 mg to about 60 mg (preferably 45 mg to about 55 mg, or 50 mg) per serving of food article, CBD is in an amount of about 12 mg to about 18 mg (preferably 14 mg to about 16 mg, or 15 mg) per serving of food article, Delta-9 THC is in an amount of about 12 mg to about 18 mg (preferably 14 mg to about 16 mg, or 15 mg) per serving of food article, and HHC is in an amount of about 20 mg to about 30 mg (preferably 22 mg to about 26 mg, or 25 mg) per serving of food article. This formulation provides a balanced blend, designed to provide enhanced relaxation (e.g., for consumers seeking a well-rounded experience combining relaxation, mild euphoria, and stress relief).

In one aspect, the food article includes a blend of CBD, CBN, Delta-8 THC, and CBG. In one aspect, in this blend, Delta-8 THC is in an amount of about 8 mg to about 12 mg (preferably 9 mg to about 11 mg, or 10 mg) per serving of food article, CBD is in an amount of about 32 mg to about 48 mg (preferably 36 mg to about 44 mg, or 40 mg) per serving of food article, CBN is in an amount of about 4 mg to about 6 mg (preferably 4.5 mg to about 5.5 mg, or 5 mg) per serving of food article, and CBG is in an amount of about 8 mg to about 12 mg (preferably 9 mg to about 11 mg, or 10 mg) per serving of food article. This formulation provides a balanced blend, designed to provide enhanced relaxation, sleep, or a combination thereof (e.g., Suited for individuals looking for help with sleep and deep relaxation without strong psychoactive effects).

In one aspect, the food article includes a blend of CBG, THCV, CBD, and Delta-10 THC. In one aspect, in this blend, Delta-10 THC is in an amount of about 4 mg to about 6 mg (preferably 4.5 mg to about 5.5 mg, or 5 mg) per serving of food article, CBD is in an amount of about 8 mg to about 12 mg (preferably 9 mg to about 11 mg, or 10 mg) per serving of food article, CBG is in an amount of about 24 mg to about 36 mg (preferably 28 mg to about 32 mg, or 30 mg) per serving of food article, and THCV is in an amount of about 16 mg to about 24 mg (preferably 18 mg to about 22 mg, or 20 mg) per serving of food article. This formulation provides a balanced blend, designed to provide enhanced energy, focus, or a combination thereof (e.g., targeted at consumers desiring a non-sedative, focus-enhancing beverage, suitable for daytime use).

In one aspect, the food article includes a blend of Delta-8 THC, Delta-9 THC, CBD, and CBC. In one aspect, in this blend, Delta-8 THC is in an amount of about 16 mg to about 24 mg (preferably 18 mg to about 22 mg, or 20 mg) per serving of food article, CBD is in an amount of about 24 mg to about 36 mg (preferably 28 mg to about 32 mg, or 30 mg) per serving of food article, CBC is in an amount of about 4 mg to about 6 mg (preferably 4.5 mg to about 5.5 mg, or 5 mg) per serving of food article, and Delta-9 THC is in an amount of about 8 mg to about 12 mg (preferably 9 mg to about 11 mg, or 10 mg) per serving of food article. This formulation provides a balanced blend, designed to provide enhanced euphoria (e.g., for recreational users seeking a gentle psychoactive experience combined with relaxation.)

In one aspect, the food article includes a blend of CBD, CBG, THCV, and CBN. In one aspect, in this blend, THCV is in an amount of about 4 mg to about 6 mg (preferably 4.5 mg to about 5.5 mg, or 5 mg) per serving of food article, CBD is in an amount of about 40 mg to about 60 mg (preferably 45 mg to about 55 mg, or 50 mg) per serving of food article, CBG is in an amount of about 8 mg to about 12 mg (preferably 9 mg to about 11 mg, or 10 mg) per serving of food article, and CBN is in an amount of about 4 mg to about 6 mg (preferably 4.5 mg to about 5.5 mg, or 5 mg) per serving of food article. This formulation provides a balanced blend, designed to reduce pain (e.g., for health-conscious consumers interested in the therapeutic potentials of cannabinoids without strong psychoactivity).

In one aspect, the food article includes a blend of Delta-9 THC, CBD, Delta-8 THC, and CBG. In one aspect, in this blend, Delta-8 THC is in an amount of about 16 mg to about 24 mg (preferably 18 mg to about 22 mg, or 20 mg) per serving of food article, CBD is in an amount of about 20 mg to about 30 mg (preferably 24 mg to about 26 mg, or 25 mg) per serving of food article, CBG is in an amount of about 4 mg to about 6 mg (preferably 4.5 mg to about 5.5 mg, or 5 mg) per serving of food article, and Delta-9 THC is in an amount of about 12 mg to about 18 mg (preferably 14 mg to about 16 mg, or 15 mg) per serving of food article. This formulation provides a balanced blend, designed to enhance relaxation, euphoria, or a combination thereof (e.g., for consumers looking for a harmonious blend of relaxation and moderate euphoria).

In one aspect, the food article includes a blend of Delta-10 THC, THCV, CBD, and CBC. In one aspect, in this blend, Delta-10 THC is in an amount of about 24 mg to about 36 mg (preferably 28 mg to about 32 mg, or 30 mg) per serving of food article, CBD is in an amount of about 16 mg to about 24 mg (preferably 18 mg to about 22 mg, or 20 mg) per serving of food article, CBC is in an amount of about 4 mg to about 6 mg (preferably 4.5 mg to about 5.5 mg, or 5 mg) per serving of food article, and THCV is in an amount of about 12 mg to about 18 mg (preferably 14 mg to about 16 mg, or 15 mg) per serving of food article. This formulation provides a balanced blend, designed to enhance creativity (e.g., for users seeking a social lubricant or a creativity booster).

In one aspect, the food article includes a blend of CBD, CBN, Delta-8 THC, and CBG. In one aspect, in this blend, Delta-8 THC is in an amount of about 8 mg to about 12 mg (preferably 9 mg to about 1 mg, or 10 mg) per serving of food article, CBD is in an amount of about 40 mg to about 60 mg (preferably 45 mg to about 55 mg, or 50 mg) per serving of food article, CBN is in an amount of about 8 mg to about 12 mg (preferably 9 mg to about 11 mg, or 10 mg) per serving of food article, and CBG is in an amount of about 4 mg to about 6 mg (preferably 4.5 mg to about 5.5 mg, or 5 mg) per serving of food article. This formulation provides a balanced blend, designed to enhance relaxation, stress relief, or a combination thereof (e.g., for those looking to unwind intensely after a stressful day or for therapeutic relaxation).

### Muscimol

In one aspect, the food articles described herein include muscimol. Muscimol, the primary psychoactive compound in Amanita muscaria mushrooms, represents a major breakthrough in the cannabis beverage industry when combined with cannabinoids. Unlike cannabinoids, which primarily interact with CB1 and CB2 receptors, muscimol works on the GABA-A receptor system, inducing a distinctly different psychoactive effect.

Not wishing to be bound by theory, muscimol works by binding to GABA-A receptors, which are responsible for inhibitory neurotransmission in the brain. This results in deep relaxation and euphoria (similar to the effects of benzodiazepines but with a more psychedelic quality), altered sensory perception and dream-like states (e.g., heightening the impact of THC, Delta-8, and CBD) and reducing anxiety and enhancing mood stabilization (e.g., complementing the anti-anxiety effects of CBD and CBG).

In one aspect, muscimol can prolong the duration of THC effects (up to 10× longer than standard cannabis beverages). In another aspect, muscimol ca amplify the intensity of psychoactive effects by modifying neural inhibition through GABA pathways. In another aspect, muscimol can create a more complex, layered high by combining the effects of CB1, CB2, and GABA-A receptor interactions.

In one aspect, muscimol is in an amount of about 10 mg to about 20 mg per serving of the food article. In another aspect, muscimol is in an amount of about 10 mg, 11 mg, 12 mg, 13 mg, 14 mg, 15 mg, 16 mg, 17 mg, 18 mg, 19 mg, or 20 mg per serving of the food article, where any value can be a power and upper endpoint of a range (e.g., 14 mg to 16 mg).

In one aspect, muscimol can be present in the food articles described herein as nanoemulsions. Muscimol in its raw form is poorly bioavailable when ingested. However, through nanoemulsification using the techniques described herein, muscimol particles can be broken down into sizes as small as, for example, 10-50 nm. The use of nanoemulsions of muscimol permits faster absorption (e.g., effects begin in 15-30 minutes instead of 1-2 hours), higher potency per dose (e.g., requiring only 15 mg per serving to achieve amplified effects), and more predictable and consistent psychoactive experience (unlike raw mushroom extracts, which vary in potency).

In one aspect, the food article includes CBD, CBN, muscimol, myrcene (discussed further below). This food article can induce deep relaxation and dream-like states, reduce anxiety and promote uninterrupted sleep, and mimics mild sedative effects without pharmaceutical intervention.

In one aspect, the food article includes THCV, muscimol, and limonene. This food article can create lucid, heightened focus while maintaining psychoactive stimulation, useful for creative tasks, writing, or deep thinking, and reduce mental fatigue and enhances visual and sensory experiences.

In one aspect, the food article includes Delta-8 THC, muscimol, and myrcene. This food article can induce a stronger, more introspective high with altered time perception, mimic the effects of microdosing psychedelics when paired with cannabinoids, and extend the duration of the high by amplifying THC absorption.

### Terpenes

In one aspect, the food articles described herein include one or more terpenes. Terpenes are naturally occurring aromatic compounds in cannabis that play a crucial role in modulating the psychoactive and therapeutic properties of cannabinoids. This embodiment nanoemulsifies specific terpenes to improve their bioavailability and absorption, allowing for a more precise and predictable effect profile.

In one aspect, the terpene is myrcene (useful as a sedative, muscle relaxant, enhances THC absorption), limonene (useful for mood elevation, stress relief, complements THCV for energy), pinene (enhances focus, pairs well with CBG/THCV for mental clarity), beta-caryophyllene (targets CB2 receptors directly, reducing inflammation & pain), linalool (provides calming, sedative effects, promotes sleep, complements CBN, humulene (promotes appetite suppression, anti-inflammatory properties), terpinolene (an uplifting, mildly sedative, antioxidant properties), ocimene (antiviral, antifungal, boosts alertness), nerolidol (provides deep relaxation, anti-anxiety, pairs well with CBD and CBN), or farnesenes (anti-spasmodic, calming, enhances pain relief properties of CBD).

In one aspect, the terpene can be present in the food articles described herein as a nanoemulsion. Terpenes in raw form are poorly bioavailable when ingested. However, through nanoemulsification using the techniques described herein, terpene particles can be broken down into sizes as small as, for example, 10-50 nm. The use of nanoemulsions of terpenes permits faster absorption, higher potency per dose, and more predictable and consistent psychoactive experience.

Paring the terpene and the with specific cannabinoids can target specific physiological and psychological effects. For example, combining CBN with linalool can promote sleep, while CBDA combined with beta-caryophyllene can provide inflammation relief.

### Methods for Producing Food Articles

The manufacturing process of the food articles described herein is designed to ensure homogeneity, stability, and effectiveness of the cannabinoid blend in the final product. It involves advanced infusion techniques, particularly nanoemulsification, to achieve a consistent and bioavailable cannabinoid profile.

In one aspect, high-quality cannabis plants are sourced, and cannabinoids (e.g., Delta-8 THC, CBG, THCV, HHC, CBD, etc.) are extracted using a solvent-free, supercritical carbon dioxide extraction method to ensure purity and safety. Each cannabinoid extract is then prepared separately, maintaining precise control over their concentrations.

In one aspect, each of the extracted cannabinoids can be subjected to a nanoemulsification process. This process involves breaking down the cannabinoid oils into microscopic particles and then suspending them in an aqueous emulsion using natural emulsifiers. Nanoemulsification significantly increases the surface area of the cannabinoids, enhancing their absorption and bioavailability when consumed. Nanoemulsification also ensures that the cannabinoids are more effectively absorbed by the body, leading to a faster and more consistent onset of effects. In one aspect, nanoemulsification is achieved using ultrasonic waves or high-shear mixing techniques, resulting in nano-sized cannabinoid droplets of each of the cannabinoids.

The nanoemulsion of each cannabinoid can be produced using any of the techniques available to fabricate emulsions and nanoemulsions. The techniques available are commonly classified as either high or low energy approaches.

High energy approaches use mechanical devices known as “homogenizers” that generate intense disruptive forces that mix the oil and water phases together, as well as break larger droplets into smaller ones. O/W emulsions are usually prepared by homogenizing an oil phase and a watery phase together in the presence of a water-soluble hydrophilic emulsifier. A variety of specialized homogenization equipment is available for fabricating emulsions and nanoemulsions that include, but are not limited to, high shear mixers, high pressure valve homogenizers, microfluidizers, colloid mills, ultrasonic homogenizers, and membrane and microchannel homogenizers.

High shear mixers are a type of rotor-stator device that homogenizes oil, water, and other ingredients in a batch process. Typically, the droplets produced by a high shear mixer range between about 1 and 10 μm in diameter. A suitable vessel may contain as a few cm³ or as large as several m³. The rapid rotation of the mixing head generates a combination of longitudinal, rotational, and radial velocity gradients in the fluids, which disrupts the interfaces between the oil and water phases, causing the liquids to become intermingled, and breaks the larger droplets into smaller ones. Efficient homogenization is achieved when the horizontal and vertical flow profiles distribute the liquids evenly throughout the vessel, which can be facilitated by having baffles fixed to the inside walls of the vessel. The design of the mixing head determines the efficiency of the homogenization process, and a number of different types are available for different situations, for example, blades, propellers, and turbines.

High-pressure valve homogenizers are used to produce fine emulsions from pre-existing emulsions (“coarse emulsion”), with emulsion droplets as small as 0.1 μm. The homogenizer has a pump that pulls the coarse emulsion into a chamber on its backstroke and then forces it through a narrow valve at the end of the chamber and on its forwards stroke it experiences a combination of intense disruptive forces that cause the larger droplets to be broken down to smaller ones. The flow regime that is responsible for disrupting the droplets in a particular high pressure valve homogenizer depends on the characteristics of the material being homogenized, the size of the homogenizer, and the design of the homogenization nozzle.

Microfluidization creates emulsions with very fine droplets whose diameter can be less than 0.1 μm. This type of homogenizer typically consists of a fluid inlet (single or double), some kind of pumping device, and an interaction chamber containing two channels. Fluids are introduced into the homogenizer, accelerated to a high velocity and then made to simultaneously impinge with each other on a solid surface, which causes the fluids to intermingle and disrupt larger droplets. In one aspect, high-pressure pumps can force the cannabinoid oil through a small chamber at up to 30,000 psi. This process results in larger but more stable droplets (e.g., 100 nm to 300 nm) that are optimized for intestinal absorption. The larger droplets can take 2-6 hours to fully absorb, ensuring a long-lasting effect.

Colloid mills are used to homogenize medium and high viscosity liquids. A colloid mill typically contains two disks: a rotor (a rotating disk) and a stator (a static disk). The liquids and other ingredients to be homogenized are usually fed into the center of the colloid mill in the form of a pre-existing emulsion. The intensity of the shear stresses (and therefore the droplet disruption forces) can be altered by varying the rotation speed, gap thickness, rotor/stator type, and throughput to reduce droplet sizes. Typically, colloid mills can be used to produce emulsions with droplet diameters around 1 and 5 μm.

Ultrasonic homogenizers use high-intensity ultrasonic waves that generate intense shear and pressure gradients within a material that disrupt droplets mainly through cavitation and turbulent effects. The present invention can use any of the available methods that are available for generating high-intensity ultrasonic waves including, but not limited to, piezoelectric transducers and liquid jet generators. In one aspect, the production of nanoemulsions can be aided by surfactants such as, for example, polysorbate 80 or lecithin, which prevent the particles from reaggregating. Ultrasonication can produce small droplets (e.g., 10 nm to 50 nm) that are absorbed directly through mucous membranes for an instant effect.

Membrane homogenizers can be used in two main ways to process emulsions, direct homogenization and premix homogenization. Direct homogenization involves forming an emulsion directly from the separate oil and water phases in the presence of a suitable emulsifier. Premix homogenization involves reducing the size of the droplets present within an existing coarse emulsion. The droplet size attained depends on the membrane pore size, the oil-water interfacial tension, the applied pressure, the flow profile of the continuous phase, and the type and amount of emulsifier used.

Low energy approaches to produce emulsions and nanoemulsions rely on the spontaneous formation of oil droplets in surfactant-oil-water mixtures which either their composition or environment is altered in a controlled way. Examples of low energy methods include, but are not limited to, spontaneous emulsification methods, emulsion inversion point methods, and phase inversion temperature methods.

Spontaneous emulsification involves titrating a mixture of oil and water-soluble surfactant into a water phase with continuous stirring. Small oil droplets are spontaneously formed at the oil-water boundary as the surfactant molecules move from the oil phase to the water phase. The spontaneous emulsification method has been used widely within the pharmaceutical industry to encapsulate and deliver lipophilic drugs. Such systems are known as either sell-emulsifying drug delivery systems (SEDDS) or self-nanoemulsifying drug delivery systems (SNEDDS) depending on the droplet size produced. Self-emulsifying formulations are readily dispersed in the gastrointestinal tract, where the motility of the stomach and small intestine provides the agitation necessary for emulsification.

Emulsion inversion point methods involve titrating water into a mixture of oil and water-soluble surfactant with continuous stirring. As increasing amounts of water are added, a W/O emulsion is initially formed, then an O/W/O emulsion, and then an O/W emulsion.

Phase inversion temperature (PIT) methods rely on heating a surfactant-oil-water mixture around or slightly above its PIT and the quench cooling with continuous stirring. When the emulsion passes through the PIT, the optimum curvature tends towards unity, thereby leading to an ultralow interfacial tension and a highly dynamic interface. For a general overview of emulsification technology, see, e.g., McClements, David J., Food Emulsions: Principles, Practices, and Techniques, 3^{rd} ed (Boca Raton, Fla. CRC Press, 2016).

In one aspect, the food article includes at least two different populations cannabinoid nanoemulsions. In one aspect, a first population has a droplet diameter of less than 100 nm and a second population has a droplet diameter of greater than or equal to 100 nm. In another aspect, the first population of the nanoemulsion has a droplet diameter of 10 nm, 20 nm, 30 nm, 40 nm, 50 nm, 60 nm, 70 nm, 80 nm, 90 nm, or less than 100 nm, where any value can be a lower or upper endpoint of a range (e.g, 30 nm to 50 nm). In another aspect, the first population of the nanoemulsion has a droplet diameter of 100 nm, 150 nm, 150 nm, 175 nm, 200 nm, 225 nm, 250 nm, 275 nm, or 300 nm, where any value can be a lower or upper endpoint of a range (e.g, 125 nm to 200 nm). In one aspect, the cannabinoid in the first and second populations of nanoemulsions are different from one another. In another aspect, the cannabinoid in the first and second populations of nanoemulsions are the same. In another aspect, the first and second populations of nanoemulsions can each include two or more different cannabinoids.

The dual-phase nanoemulsion system, strategically combines small and larger nanoemulsions to optimize both immediate and sustained cannabinoid absorption. This system overcomes the limitations of existing cannabis beverages, which typically rely on single-phase emulsions that result in either a rapid but short-lived effect (small nanoemulsions absorbed quickly but wearing off too soon) or a delayed and unpredictable effect (larger droplets requiring full digestion before onset). By integrating two differently sized nanoemulsions in the same food article, this formulation delivers both fast-acting and long-lasting effects, providing a more controlled, enjoyable, and efficient user experience.

Not wishing to be bound by theory, cannabinoid nanoemulsions with a small droplet size (i.e., less than 100 nm) are small enough to bypass the digestive tract and be absorbed directly into the bloodstream via mucous membranes and stomach lining. This allows for rapid cannabinoid uptake, mimicking the speed of alcohol. Some of the ultra-small nanoparticles can be absorbed through the mouth and esophagus lining before reaching the stomach. The remaining small nanoparticles penetrate the stomach lining, entering the bloodstream within 5-15 minutes. The cannabinoid nanoemulsions with a small droplet size possess higher bioavailability when compared to standard edibles or larger nanoemulsions, which results in a quick, intense onset ideal for immediate relaxation, focus, or energy. For example, a blend composed of a nanoemulsion of Delta-8, Delta-9, and CBD at 10 nm can provide an initial euphoric effect within minutes, making it ideal for social settings.

In the case of larger nanoemulsions (greater than 100 nm), the particles do not absorb in the mouth or stomach. Instead, they travel into the small intestine, where bile salts break down the nanoemulsion, allowing for gradual cannabinoid release into the bloodstream over 2-6 hours. Larger nanoemulsions are emulsified by bile salts and absorbed slowly through intestinal walls. Moreover, the cannabinoids undergo first-pass metabolism, further delaying onset but extending duration. The use of larger cannabinoid nanoemulsions ensures a slower, sustained psychoactive experience, preventing rapid tolerance buildup while reducing the crash cycle associated with short-duration cannabis products.

Thus, by combining small and large nanoemulsions, the food article delivers a controlled experience with (1) an immediate onset (e.g., 5-15 min), where small cannabinoids absorb through mucous membranes (fast high) followed by (2) extended effects (e.g., 1-6 hrs), where cannabinoids absorb through the intestines (slow, sustained high).

The ratio of the first and second population of the nanoemulsions can vary depending upon desired response. In one aspect, the weight ratio of the first population to the second population is from 4:1 to 1:4, or 4:1, 3:1, 2:1, 1:1, 1:2, 1:3, or 1:4, where any value can be a lower and upper endpoint of a range (e.g, 3:1 to 1:1). For example, a blend composed of 70 weight percent small nanoemulsion (e.g., 10 nm, fast-acting Delta-8 THC) can provide instant relaxation while the 30 weight percent of a large nanoemulsion (e.g., 100 nm, slow-release CBD & CBG) can provide a sustained calming effect. In another aspect, a blend composed of 50 weight percent small nanoemulsion (e.g., 10 nm, fast-acting THCV and CBG) can provide immediate mental clarity while the 50 weight percent of a large nanoemulsion (e.g., 100 nm, slow-release THCV) can provide steady focus throughout the day.

In addition to cannabinoid nanoemulsions, the food articles can include nanoemulsions of muscimol and terpenes as described herein. Depending upon the desired properties of the food article, muscimol and the terpenes can be processed into different populations of nanoemulsions similar to that of the cannabinoids described above to optimize bioavailability and effect targeting.

Depending upon the nature of the food article, in one aspect, the nanoemulsified cannabinoids are then blended in specific ratios or amounts as discussed above to produce a variety of different products. In one aspect, the food article comprises a gummy, a brownie, a cookie, a pill, a capsule, a lozenge, or a dissolvable strip that contains specified blends of cannabinoids in specific amounts or ratios.

In another aspect, the food article is a beverage. In one aspect, the beverage is produced by blending the selected nanoemulsified cannabinoids in specified amounts in water. Additional ingredients such as natural flavors, sweeteners, and preservatives are added at this stage, adhering to food safety standards.

A “sweetener” is a compound, extract, or composition that imparts a sweet taste to a food of beverage. Inclusion of a sweetener may assist in improving the flavor of a food or beverage product. In one aspect, the beverages disclosed herein do not contain any added sweeteners. In another aspect, the beverages disclosed herein contain one or more added sweeteners.

In one aspect, the sweetener is a natural sweetener. Examples of sweeteners useful herein include, but are not limited to, cane sugar, beet sugar, coconut sugar, agave nectar, honey, maple syrup, molasses, barley malt syrup, brown rice syrup, date sugar, xylitol, erythritol, lucuma powder, monk fruit extract, stevia extract, or any combination thereof. In one aspect, the sweetener can add calories or other nutrients such as, for example, fiber to the beverages. In an alternative aspect, the sweetener is a non-caloric sweetener.

A “preservative” is a compound or composition that is added to food and/or beverage products to prevent spoilage and prolong shelf life. In one aspect, a preservative can be an artificial or added preservative, such as, for example, sodium benzoate, benzoic acid, a nitrite, a sulfite, sodium sorbate, potassium sorbate, or a similar compound. In one aspect, added preservatives are not found in natural products. In another aspect, the beverages described herein do not contain any added or artificial preservatives.

In one aspect, the beverages described herein include a natural preservative. “Natural preservatives” as described herein include antioxidants such as, for example, vitamins A, C, and E (often present as “mixed tocopherols”). In another aspect, the natural preservative can be rosemary oil or rosemary leaf extract, lemon juice, cinnamon extract, citric acid, or a combination thereof.

“Natural flavors” are defined by the Code of Federal Regulations as essential oils, oleoresins, essences or extractives, protein hydrolysates, distillates, or any products of roasting, heating, or enzymolysis, which contain the flavoring constituents derived from a spice, fruit or fruit juice, vegetable or vegetable juice, edible yeast, herb, bark, bud, root, leaf, or similar plant material, or meat, seafood, poultry, eggs, dairy products, or fermentation products thereof, whose significant function in food is flavoring rather than nutritional. In one aspect, the beverages disclosed herein include one or more added natural flavors. In an alternative aspect, the beverages disclosed herein are free from any added natural flavors other than those already possessed by the ingredients described herein.

In one aspect, after the nanoemulsified cannabinoids have been blended in water with the optional natural flavors, sweeteners, and preservatives, the aqueous mixture can be subsequently homogenized to ensure uniform distribution of all components, resulting in a consistent beverage in terms of taste, appearance, and cannabinoid dosage. Before and/or after homogenization, the aqueous composition with the blend of cannabinoids can be carbonated using techniques known in the art to produce a carbonated beverage.

Once the beverage has been produced, the beverage is packaged in a suitable container. For example, the beverage can be introduced into cans or bottles and sealed. The container is labeled with all necessary information, including cannabinoid content, serving size, and usage instructions.

### ASPECTS

Aspect 1. A food article comprising a blend of two or more cannabinoids.

Aspect 2. The food article of Aspect 1, wherein the cannabinoid is selected from the group consisting of Δ8-tetrahydrocannabinol (Delta-8 THC), cannabigerol (CBG), tetrahydrocannabivarin (THCV), hexahydrocannabinol (HHC), cannabidiol (CBD), Δ9-tetrahydrocannabinol (Delta-9 THC), Δ10-tetrahydrocannabinol (Delta-10 THC), tetrahydrocannabiphorol (THC-P), hydrogenated THC-P (HHC-P), cannabinol (CBN), cannabichromene (CBC), cannabidiolic Acid (CBDA), tetrahydrocannabinolic Acid (THCA), and any combination thereof.

Aspect 3. The food article of Aspect 1, article comprising a blend of three, four or five cannabinoids.

Aspect 4. The food article of Aspect 1, wherein the article comprising one of the following blends of cannabinoids:
Delta-8 THC, CBG, CBD, THCV, and HHC;
Delta-8 THC, CBG, CBD, and HHC;
CBD, Delta-9 THC, Delta-8 THC, and HHC;
CBD, CBN, Delta-8 THC, and CBG;
CBG, THCV, CBD, and Delta-10 THC;
Delta-8 THC, Delta-9 THC, CBD, and CBC;
CBD, CBG, THCV, and CBN;
Delta-9 THC, CBD, Delta-8 THC, and CBG;
Delta-10 THC, THCV, CBD, and CBC; or
CBD, CBN, Delta-8 THC, and CBG.

Aspect 5. The food article of Aspect 4, wherein the food article comprises blend (a), wherein Delta-8 THC is in an amount of about 12 mg to about 18 mg per serving of food article, CBG is in an amount of about 16 mg to about 24 mg per serving of food article, CBD is in an amount of about 20 mg to about 30 mg per serving of food article, THCV is in an amount of about 5 mg to about 9 mg per serving of food article, and HHC is in an amount of about 8 mg to about 12 mg per serving of food article.

Aspect 6. The food article of Aspect 4, wherein the food article comprises blend (a), wherein Delta-8 THC is in an amount of about 16 mg to about 24 mg per serving of food article, CBG is in an amount of about 12 mg to about 18 mg per serving of food article, CBD is in an amount of about 24 mg to about 36 mg per serving of food article, THCV is in an amount of about 4 mg to about 6 mg per serving of food article, and HHC is in an amount of about 8 mg to about 12 mg per serving of food article.

Aspect 7. The food article of Aspect 6, wherein the food article provides enhanced relaxation, stress relief, or a combination thereof.

Aspect 8. The food article of Aspect 4, wherein the food article comprises blend (a), wherein Delta-8 THC is in an amount of about 8 mg to about 12 mg per serving of food article, CBG is in an amount of about 16 mg to about 24 mg per serving of food article, CBD is in an amount of about 12 mg to about 18 mg per serving of food article, THCV is in an amount of about 8 mg to about 12 mg per serving of food article, and HHC is in an amount of about 4 mg to about 6 mg per serving of food article.

Aspect 9. The food article of Aspect 8, wherein the food article provides enhanced energy, focus, or a combination thereof.

Aspect 10. The food article of Aspect 4, wherein the food article comprises blend (b), wherein Delta-8 THC is in an amount of about 4 mg to about 6 mg per serving of food article, CBG is in an amount of about 24 mg to about 36 mg per serving of food article, CBD is in an amount of about 32 mg to about 48 mg per serving of food article, and HHC is in an amount of about 4 mg to about 6 mg per serving of food article.

Aspect 11. The food article of Aspect 10, wherein the food article enhances sleep.

Aspect 12. The food article of Aspect 4, wherein the food article comprises blend (c), wherein Delta-8 THC is in an amount of about 40 mg to about 60 mg per serving of food article, CBD is in an amount of about 12 mg to about 18 mg per serving of food article, Delta-9 THC is in an amount of about 12 mg to about 18 mg per serving of food article, and HHC is in an amount of about 20 mg to about 30 mg per serving of food article.

Aspect 13. The food article of Aspect 12, wherein the food article enhances relaxation.

Aspect 14. The food article of Aspect 4, wherein the food article comprises blend (d), wherein Delta-8 THC is in an amount of about 8 mg to about 12 mg per serving of food article, CBD is in an amount of about 32 mg to about 48 mg per serving of food article, CBN is in an amount of about 4 mg to about 6 mg per serving of food article, and CBG is in an amount of about 8 mg to about 12 mg per serving of food article.

Aspect 15. The food article of Aspect 14, wherein the food article enhances relaxation, sleep, or a combination thereof.

Aspect 16. The food article of Aspect 4, wherein the food article comprises blend (e), wherein Delta-10 THC is in an amount of about 4 mg to about 6 mg per serving of food article, CBD is in an amount of about 8 mg to about 12 mg per serving of food article, CBG is in an amount of about 24 mg to about 36 mg per serving of food article, and THCV is in an amount of about 16 mg to about 24 mg per serving of food article.

Aspect 17. The food article of Aspect 16, wherein the food article enhances energy, focus, or a combination thereof.

Aspect 18. The food article of Aspect 4, wherein the food article comprises blend (f), wherein Delta-8 THC is in an amount of about 16 mg to about 24 mg per serving of food article, CBD is in an amount of about 24 mg to about 36 mg per serving of food article, CBC is in an amount of about 4 mg to about 6 mg per serving of food article, and Delta-9 THC is in an amount of about 8 mg to about 12 mg per serving of food article.

Aspect 19. The food article of Aspect 18, wherein the food article enhances euphoria.

Aspect 20. The food article of Aspect 4, wherein the food article comprises blend (g), wherein THCV is in an amount of about 4 mg to about 6 mg per serving of food article, CBD is in an amount of about 40 mg to about 60 mg per serving of food article, CBG is in an amount of about 8 mg to about 12 mg per serving of food article, and CBN is in an amount of about 4 mg to about 6 mg per serving of food article.

Aspect 21. The food article of Aspect 20, wherein the food article reduces pain.

Aspect 22. The food article of Aspect 4, wherein the food article comprises blend (h), wherein Delta-8 THC is in an amount of about 16 mg to about 24 mg per serving of food article, CBD is in an amount of about 20 mg to about 30 mg per serving of food article, CBG is in an amount of about 4 mg to about 6 mg per serving of food article, and Delta-9 THC is in an amount of about 12 mg to about 18 mg per serving of food article.

Aspect 23. The food article of Aspect 22, wherein the food article enhances relaxation, euphoria, or a combination thereof.

Aspect 24. The food article of Aspect 4, wherein the food article comprises blend (i), wherein Delta-10 THC is in an amount of about 24 mg to about 36 mg per serving of food article, CBD is in an amount of about 16 mg to about 24 mg per serving of food article, CBC is in an amount of about 4 mg to about 6 mg per serving of food article, and THCV is in an amount of about 12 mg to about 18 mg per serving of food article.

Aspect 25. The food article of Aspect 24, wherein the food article enhances creativity.

Aspect 26. The food article of Aspect 4, wherein the food article comprises blend (j), wherein Delta-8 THC is in an amount of about 8 mg to about 12 mg per serving of food article, CBD is in an amount of about 40 mg to about 60 mg per serving of food article, CBN is in an amount of about 8 mg to about 12 mg per serving of food article, and CBG is in an amount of about 4 mg to about 6 mg per serving of food article.

Aspect 27. The food article of Aspect 26, wherein the food article enhances relaxation, stress relief, or a combination thereof.

Aspect 28. The food article of any one of Aspects 1-27, wherein each cannabinoid comprises nanoparticles.

Aspect 29. The food article of any one of Aspects 1-27, wherein the blend comprises at least two different populations cannabinoid nanoemulsions.

Aspect 30. The food article of any one of Aspects 1-27, wherein the blend comprises at least two different populations cannabinoid nanoemulsions, wherein a first population has a droplet diameter of less than 100 nm and a second population has a droplet diameter of greater than or equal to 100 nm.

Aspect 31. The food article of Aspect 30, wherein the first population has a droplet diameter of 10 nm to 50 nm and the second population has a droplet diameter of 100 nm to 300 nm.

Aspect 32. The food article of Aspect 30 or 31, wherein a ratio of the first population to the second population is from 4:1 to 1:4.

Aspect 33. The food article of any one of Aspects 1-32, wherein the food article comprises further comprises muscimol, a terpene, or a combination thereof.

Aspect 34. The food article of Aspect 33, wherein muscimol is in an amount of about 10 mg to about 20 mg per serving of the food article.

Aspect 35. The food article of Aspect 33, wherein the terpene is selected from the group consisting of myrcene, limonene, pinene, beta-caryophyllene, linalool, humulene, terpinolene, ocimene, nerolidol, farnesenes, and any combination thereof.

Aspect 36. The food article of any one of Aspects 33-35, wherein muscimol, the terpene, or the combination thereof comprises nanoparticles.

Aspect 37. The food article of any one of Aspects 1-36, wherein the food article comprises a gummy, a brownie, a cookie, a pill, a capsule, a lozenge, or a dissolvable strip.

Aspect 38. The food article of any one of Aspects 1-36, wherein the food article comprises a beverage.

Aspect 39. The food article of Aspect 38, wherein the beverage is 12 fluid ounces.

Aspect 40. The food article of Aspect 38 or 39, wherein the beverage further comprises natural flavors, sweeteners, preservatives, or any combination thereof.

Aspect 41. The food article of any one of Aspects 38-40, wherein the beverage is carbonated.

Aspect 42. A food article comprising (1) a blend of one or more cannabinoids and (2) muscimol, a terpene, or a combination thereof.

Aspect 43. A method for making a beverage comprising a blend of two or more cannabinoids, the method comprising
forming nanoparticles of each cannabinoid in each blend;
mixing the nanoparticles of each cannabinoid in water to produce a first composition; and
homogenizing the first composition to produce the beverage.

Aspect 44. The method of Aspect 43, wherein the method comprises blending at least two different populations cannabinoid nanoparticles, wherein a first population has a particle diameter of less than 100 nm and a second population has a particle diameter of greater than or equal to 100 nm.

Aspect 45. The method of Aspect 43 or 44, wherein in step (2) mixing muscimol, a terpene, or a combination thereof in the first composition.

Aspect 46. The method of Aspect 45, wherein muscimol, the terpene, or the combination thereof comprises nanoparticles.

Aspect 47. The method of any one of Aspects 43-46, wherein in step (2) mixing a natural flavor, a sweetener, a preservative, or any combination thereof in the first composition.

Aspect 48. The method of any one of Aspects 43-47, wherein the method further comprises carbonating the beverage.

Various modifications and variations can be made to the compounds, compositions, and methods described herein. Other aspects of the compounds, compositions, and methods described herein will be apparent from consideration of the specification and practice of the compounds, compositions, and methods disclosed herein. It is intended that the specification and examples be considered as exemplary.

What is claimed:

1. A food article comprising a blend of two or more cannabinoids.

2. The food article of claim 1, wherein the cannabinoid is selected from the group consisting of Δ8-tetrahydrocannabinol (Delta-8 THC), cannabigerol (CBG), tetrahydrocannabivarin (THCV), hexahydrocannabinol (HHC), cannabidiol (CBD), Δ9-tetrahydrocannabinol (Delta-9 THC), Δ10-tetrahydrocannabinol (Delta-10 THC), tetrahydrocannabiphorol (THC-P), hydrogenated THC-P (HHC-P), cannabinol (CBN), cannabichromene (CBC), cannabidiolic Acid (CBDA), tetrahydrocannabinolic Acid (THCA), and any combination thereof.

3. The food article of claim 1, article comprising a blend of three, four or five cannabinoids.

4. The food article of claim 1, wherein each cannabinoid comprises nanoparticles.

5. The food article of claim 1, wherein the blend comprises at least two different populations cannabinoid nanoparticles.

6. The food article of claim 1, wherein the blend comprises at least two different populations cannabinoid nanoemulsion, wherein a first population has a droplet diameter of less than 100 nm and a second population has a droplet diameter of greater than or equal to 100 nm.

7. The food article of claim 6, wherein the first population has a droplet diameter of 10 nm to 50 nm and the second population has a droplet diameter of 100 nm to 300 nm.

8. The food article of claim 6, wherein a ratio of the first population to the second population is from 4:1 to 1:4.

9. The food article of claim 1, wherein the food article comprises further comprises muscimol, a terpene, or a combination thereof.

10. The food article of claim 9, wherein muscimol is in an amount of about 10 mg to about 20 mg per serving of the food article.

11. The food article of claim 9, wherein the terpene is selected from the group consisting of myrcene, limonene, pinene, beta-caryophyllene, linalool, humulene, terpinolene, ocimene, nerolidol, farnesenes, and any combination thereof.

12. The food article of claim 9, wherein muscimol, the terpene, or the combination thereof comprises a nanoemulsion.

13. The food article of claim 1, wherein the food article comprises a gummy, a brownie, a cookie, a pill, a capsule, a lozenge, or a dissolvable strip.

14. The food article of claim 1, wherein the food article comprises a beverage.

15. The food article of claim 14, wherein the beverage further comprises natural flavors, sweeteners, preservatives, or any combination thereof.

16. The food article of claim 14, wherein the beverage is carbonated.

17. A method for making a beverage comprising a blend of two or more cannabinoids, the method comprising
(1) forming nanoparticles of each cannabinoid in each blend;
(2) mixing the nanoparticles of each cannabinoid in water to produce a first composition; and
(3) homogenizing the first composition to produce the beverage.

18. The method of claim 17, wherein the method comprises blending at least two different populations cannabinoid nanoparticles, wherein a first population has a particle diameter of less than 100 nm and a second population has a particle diameter of greater than or equal to 100 nm.

19. The method of claim 17, wherein in step (2) mixing muscimol, a terpene, or a combination thereof in the first composition.

20. The method of claim 19, wherein muscimol, the terpene, or the combination thereof comprises a nanoemulsion.
